(19) United States
(12) Patent Application Publication
(10) Pub. No.: US 2025/0348226 A1
(43) Pub. Date: Nov. 13, 2025

(54) WRITE MANAGEMENT MECHANISM FOR ENHANCING PERFORMANCE AND LIFESPAN OF QUAD-LEVEL CELL FLASH MEMORY

(71) Applicant: Silicon Motion, Inc., Hsinchu County (TW)

(72) Inventors: Tsung-Chieh Yang, Hsinchu City (TW); Po-Sheng Chou, Miaoli County (TW)

(73) Assignee: Silicon Motion, Inc., Hsinchu County (TW)

(21) Appl. No.: 18/661,689

(22) Filed: May 12, 2024

(51) Int. Cl. G06F 3/06

(52) U.S. Cl. CPC G06F 3/0616; G06F 3/064; G06F 3/0659; G06F 3/0679

(57) ABSTRACT

A method of controlling a flash memory includes: in response to a host write command, writing host data associated with the host write command into a target block of a region of the flash memory in a specific write mode with one-shot programming; performing a block reliability examination on the target block of the region to generate a block reliability indication; selecting one of a direct conversion mode and a garbage collection-based conversion mode according to the block reliability indication; and performing a cell level reconfiguration with respect to the target block according to the selected conversion mode.

### BACKGROUND OF THE INVENTION

### 1. Field of the Invention

The present invention relates to flash memory, and more particularly to methods of controlling a quad-level cell (QLC) flash memory for performance and endurance enhancement and related memory controller and data storage device thereof.

### 2. Description of the Prior Art

Quadruple-level cell (QLC) flash memory is an advanced storage technology, whose primary advantage lies in significantly increasing storage density. Each QLC memory cell can store information of 4 bits, meaning that QLC technology can store more information in the same physical space compared to single-level cell (SLC), multi-level cell (MLC), and triple-level cell (TLC) technologies. This higher storage density makes QLC flash memory a highly cost-effective storage solution, particularly suitable for large data storage and enterprise applications. However, as each QLC memory cell may have 16 possible charge states (corresponding to 4 bits), this leads to higher difficulty in discerning charge states and a greater likelihood of errors during writing and reading. Consequently, QLC flash memory has slower read and write speeds and a relatively higher rate of read and write errors compared to other technologies. It is evident that QLC flash memory requires more advanced write management mechanisms to overcome its inherent shortcomings.

### SUMMARY OF THE INVENTION

With this in mind, it is object of the present invention to provide block management and configuration mechanism for use in QLC flash memory. In embodiments of the present invention, a method of controlling a flash memory is provide to execute a block reconfiguration with respect to a TLC block of the flash memory, which selectively perform a direct conversion to reconfigure and program the TLC block as a QLC block in accordance with a result of block reliability examination performed on the TLC block. Such approach ensures write performance of QLC flash memory while taking storage reliability into account. In embodiments of the present invention, a method of determining a strategy for controlling the QLC flash memory is provided. This method would select either a performance-oriented strategy or a lifespan-oriented strategy according to a wearing status of the QLC flash memory, which ensures write performance of QLC flash memory while taking device lifespan into account.

According to one embodiment, a method of controlling a flash memory is provided. The method comprises: in response to a host write command, writing host data associated with the host write command into a target block of a region of the flash memory in a specific write mode with one-shot programming; performing a block reliability examination on the target block of the region to generate a block reliability indication; selecting one of a direct conversion mode and a garbage collection-based (GC-based) conversion mode according to the block reliability indication; and performing a cell level reconfiguration with respect to the target block according to the selected conversion mode.

According to one embodiment, a memory controller for use in a flash memory is provided. The memory controller comprises: a storage unit and a processing unit. The storage unit is configured to store program codes. The processing unit is configured to execute the program code to perform operations on the flash memory, comprising: in response to a host write command, writing host data associated with the host write command into a target block of a region of the flash memory in a specific write mode with one-shot programming; performing a block reliability examination on the target block of the region to generate a block reliability indication; selecting one of a direct conversion mode and a garbage collection-based conversion mode according to the block reliability indication; and performing a cell level reconfiguration with respect to the target block according to the selected conversion mode.

According to one embodiment, a method of controlling a flash memory is provided. The method comprises: selecting a first strategy to configure the flash memory and control the flash memory based on the first strategy; determining whether a wearing condition indication value regarding the flash memory exceeds a predetermined threshold; and selecting a second strategy to configure the flash memory and control the flash memory based on the second strategy if the wearing condition indication value exceeds the predetermined threshold. Specifically, in the first strategy, a garbage collection operation is not immediately performed once an available number of blocks in a first region of the flash memory goes below a lower bound. In the second strategy, the garbage collection operation is immediately performed once the available number of blocks in the first region of the flash memory goes below a lower bound.

According to one embodiment, a memory controller for use in a flash memory is provided. The memory controller comprises: a storage unit and a processing unit. The storage unit is configured to store program codes. The processing unit is configured to execute the program code to perform operations on the flash memory, comprising: selecting a first strategy to configure the flash memory and control the flash memory based on the first strategy; determining whether a wearing condition indication value regarding the flash memory exceeds a predetermined threshold; and selecting a second strategy to configure the flash memory and control the flash memory based on the second strategy if the wearing condition indication value exceeds the predetermined threshold. Specifically, in the first strategy, a garbage collection operation is not immediately performed once an available number of blocks in a first region of the flash memory goes below a lower bound. In the second strategy, the garbage collection operation is immediately performed once the available number of blocks in the first region of the flash memory goes below a lower bound.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a data storage device according to one embodiment of the present invention.

FIG. 2 is a flow chart of performing a block reliability examination on a target block according to one embodiment of the present invention.

FIG. 3 illustrates how a direct conversion mode and a GC-based conversion mode are performed according to one embodiment of the present invention.

FIG. 4 illustrates a flow chart of a method of controlling a flash memory according to one embodiment of the present invention.

FIG. 5 illustrates configuration and control of a flash memory based on a performance-oriented strategy and a lifespan-oriented strategy.

FIG. 6 illustrates a flow chart of a method of controlling a flash memory according to one embodiment of the present invention.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

Reference throughout this specification to “one embodiment” or “an embodiment” means that a particular feature, structure or characteristic described in connection with the embodiment or example is included in at least one embodiment of the present embodiments. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

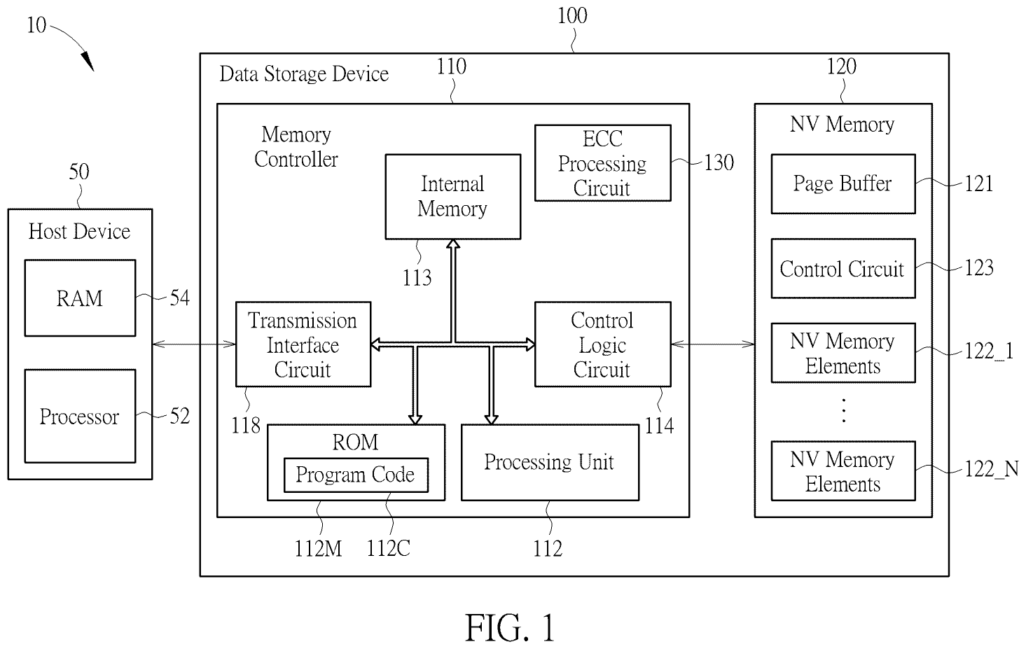

FIG. 1 is a schematic diagram illustrating an electronic device and a data storage device according to one embodiment of the present invention. As illustrated an electronic device 10 comprises a host device 50 and a data storage device 100. The host device 50 may comprise: at least one processor 52 configured to control operations of the host device 50, and a random access memory 54 configured to store data and information required by the processor 52. Examples of the host device 50 may include, but are not limited to: a smartphone, a tablet computer, a wearable device, a personal computer (such as, a desktop computer or a laptop computer), an imaging device (such as, a digital still camera or a video camera), a game console, a car navigation system, a printer, a scanner, or a server system. Examples of the data storage device 100 may include, but are not limited to: a portable memory device (such as a memory card conforming to SD/MMC, CF, MS, XD, or UFS specifications), a solid-state drive (SSD), and various embedded storage devices (such as an embedded storage device conforming to UFS or EMMC specifications).

According to various embodiments, the data storage device 100 may comprise a controller (such as, a memory controller 110) and may further comprise a non-volatile (NV) memory 120. The NV memory 120 is configured to store data and information. The NV memory 120 may comprise one or more NV memory elements, such as a plurality of NV memory elements 122_1-122_N. For example, the NV memory 120 may be a flash memory, and the NV memory elements 122_1-122_N may be a plurality of flash memory chips or a plurality of flash memory dies, respectively, but the present invention is not limited thereto. In addition, the NV memory 120 may comprise memory cells having a two-dimensional structure or memory cells having a three-dimensional structure.

As shown in FIG. 1, the memory controller 110 may comprise a processing unit 112, a read-only memory (ROM) 112M, an internal memory 113, a control logic circuit 114, and a transmission interface circuit 118, an error correction coding (ECC) processing circuit 130. At least one portion of these circuits and components may be coupled to one another through a bus. The internal memory 113 can be implemented by one or more RAM devices. For example, the internal memory 113 may comprise a static RAM (SRAM) and/or a dynamic RAM (DRAM). The internal memory 113 could be configured to provide internal storage space for the memory controller 110, for example, temporarily storing information, such as data, addresses, commands, mapping information, and/or variables/parameters. In some embodiments, the memory controller 110 may not include the internal memory 113. Instead, the memory controller 110 may rely on host memory buffer (HMB) technology. With the HMB technology, the memory controller 110 could utilize the RAM 54 (such as DRAM) of the host device 50, as a whole, a part or an extension of the internal memory 113, thereby improving read and write performance of the data storage device 100.

In addition, the ROM 112M in this embodiment is configured to store program code 112C, and the microprocessor 112 is configured to execute the program code 112C, thereby controlling access to the NV memory 120. The program code 112C may include one or more program modules, such as boot loader code. When the data storage device 100 obtains power from the host device 50, the processing unit 112 may execute an initialization process of the data storage device 100 by executing the program code 112C. During the initialization process, the microprocessor 112 may load a set of in-system programming (ISP) codes (not shown in FIG. 1) from the NV memory 120. The microprocessor 112 can execute the ISP codes so that the data storage device 100 can be operable to perform various functions. According to one embodiment of the present invention, the set of ISP codes may include, but are not limited to: one or more program modules associated with memory access (e.g., reading, writing, and erasing), such as, a read operation module, a lookup table module, a wear leveling module, a read refresh module, a read reclaim module, and a garbage collection module, an sudden power-off recovery (SPOR) module, which are provided to perform corresponding reading, lookup table querying, wear leveling, read refreshing, read reclaiming, garbage collection, SPOR and other operations.

The memory controller 110 controls reading, writing, and erasing of the NV memory 120 through a control logic circuit 114. In addition, the memory controller 110 could perform writing of data based on host commands from the host device 50 and writing of valid data which is read from the NV memory 120 by a garbage collection and/or a wear-leveling operation concurrently. The transmission interface circuit 118 may conform to a specific communications specification, such as, Universal Serial Bus (USB) specification, Secure Digital (SD) interface, Ultra High Speed-I (UHS-I) interface, Ultra High Speed-II Compact Flash (UHS-II), (CF) interface, Multimedia card (MMC) interface, embedded Multimedia Card (eMMC) specification, Advanced Technology Attachment (ATA), Serial Advanced Technology Attachment (SATA), Parallel Advanced Technology Attachment (PATA), Peripheral Component Interconnect Express (PCI-E), and Universal Flash Storage (UFS) specification, and may perform communications with the host device 50 according to the specific communications specification.

Typically, the host device 50 may indirectly access the memory device 100, through transmitting host commands and corresponding logic addresses to the memory controller 110. The memory controller 110 receives the host commands and the logic addresses, and translates the host commands to memory operation commands, and further controls the NV memory 120 with the memory operation commands to perform read, program or erase operations upon memory cells or data pages having physical addresses within the NV memory 120. The NV memory 120 includes one or more page buffers 121 (which may be implemented by SRAM), and one or more control circuits 123. Data that the memory controller 110 intends to program to the NV memory 120 will be written into the page buffer 121 before being programmed to the memory cells. The one or more control circuits 123 will read, program, or erase data based on the memory operation commands sent by the memory controller 110. When the memory controller 110 performs an erase operation on any one of the NV memory elements 122_1-122_N, at least one block in the NV memory element 122_k may be erased. In addition, each block of the NV memory element 122_k can include multiple pages, and access operations (for example, read or write) are performed on one or more pages.

In one embodiment, each of the NV memory elements 122_1-122_N may be a NV memory die or chip. Each of NV memory dies 122_1-122_N is equipped with control circuitry for executing memory operation commands issued by the memory controller 110. Additionally, each of NV memory dies 122_1-122_N may include multiple planes. Each plane might have multiple blocks composed of memory cells, along with associated row and column control circuitry. Memory cells in each plane can be arranged in either a 2D or 3D memory structure. Moreover, through multi-plane operation commands, various memory operations can be parallel or simultaneously performed on different planes. That is, memory operations can be applied parallel or simultaneously on memory blocks of different planes to perform multi-plane reading, writing or erasing operations. In one embodiment, the memory controller 110 can be utilized to combine memory blocks of the NV memory 120 into multiple super blocks. In one embodiment, a composition of a super block can span across NV memory chips 122_1-122_N. Additionally, the super block can be utilized as one or more storage blocks in each of NV memory chips 122_1-122_N.

In one embodiment, a logical-to-physical (L2P) address mapping table having multiple L2P address mapping entries, can be divided into multiple mapping groups. Each mapping group includes a part of entries of the L2P address mapping table and is utilized for performing logical-to-physical address translation. These L2P mapping groups are permanently stored in blocks of NV memory 120 and are loaded into the internal memory 113 when needed. Similarly, a physical-to-logical (P2L) address mapping table having multiple P2L address mapping entries, can be divided into multiple mapping groups. Each mapping group includes a part of entries of the P2L address mapping table and is utilized for performing physical to logical address translation. These P2L mapping groups are permanently stored in blocks of NV memory 120.

In embodiments of the present invention, the memory controller 110 is operable to support various write modes. In a single-level cell (SLC) write mode supported by the memory controller 110, data having 1 bit is written per one memory cell. In a multiple-level cell (MLC) write mode supported by the memory controller 110, data having 2 bits is written per one memory cell. In a triple-level cell (TLC) write mode supported by the memory controller 110, data having 3 bits is written per one memory cell. In a quad-level cell (QLC) write mode supported by the memory controller 110, data having 4 bits is written per one memory cell. Thus, the memory controller 110 would select one of the supported write modes to perform a write operation on the NV memory 120.

On the other hand, each of the NV memory elements 122_1-122_N of the NV memory 120 may be realized as a flash memory configured to store one or multiple bits per memory cell, for example, a SLC flash memory configured to store 1-bit data per memory cell, a MLC flash memory configured to store 2-bit data per memory cell, a TLC flash memory configured to store 3-bit data per memory cell, and a QLC flash memory configured to store 4-bit data per memory. Furthermore, blocks of the NV memory 120 may include pages, wherein each block may function as a minimum erase unit. Each page of the NV memory 120 includes memory cells connected to a single word line and function as a unit of data write/read operation. In addition, a word line may also function as a unit of data write/read operation.

In one embodiment, the NV memory 120 could be configured as an MLC flash memory, capable of storing two bits per memory cell. Typically, two page data (i.e., lower page data and upper page data) is written into memory cells connected to a single word line, allowing two bits to be stored per memory cell. However, any region (e.g., one or more blocks) of the MLC flash memory 120 may be optionally designated as a specific region configured to store only one bit per memory cell for performance enhancement. This flexibility enables the creation of a SLC region (i.e., a SLC cache) within the MLC memory 120 itself. The memory controller 110 would perform a write operation in the SLC write mode to program data into the SLC region, where data of only one page is written in memory cells connected to a single word line. This ensures that in the SLC region, each block functions as a SLC block, with data storage capacity tailored to store only one bit per memory cell.

In one embodiment, the NV memory 120 could be configured as a TLC flash memory, capable of storing three bits per memory cell. Typically, three page data (i.e., lower page data, middle page data, and upper page data) is written into memory cells connected to a single word line, allowing three bits to be stored per memory cell. However, any region (e.g., one or more blocks) of the TLC flash memory 120 may be optionally designated as the SLC region (storing one bits per memory cell) and/or an MLC region configured to store two bits per memory cell for performance enhancement. This flexibility enables the creation of a SLC region (i.e., a SLC cache) and/or an MLC region within the TLC memory 120 itself. The memory controller 110 would perform a write operation in the MLC write mode to program data into the MLC region, where data of two pages is written in memory cells connected to a single word line. This ensures that in the MLC region, each block functions as an MLC block, with data storage capacity tailored to store only two bits per memory cell.

In one embodiment, the NV memory 120 could be configured as a QLC flash memory, capable of store four bits per memory cell. Typically, four page data (i.e., lower page data, middle page data, upper page data and top page data) is written into memory cells connected to a single word line, allowing four bits to be stored per memory cell. However, any region (e.g., one or more blocks) of the QLC flash memory 120 may be optionally designated as the SLC region (storing one bit per memory cell), the MLC region (storing two bits per memory cell) and/or a TLC region configured to store three bits per memory cell for performance enhancement. This flexibility enables the creation of a SLC region (i.e., a SLC cache), an MLC region and/or a TLC region within the QLC memory 120. The memory controller 110 would perform a write operation in the TLC write mode to program data into the TLC region, where data of three pages is written in memory cells connected to a single word line. This ensures that in the TLC region, each block functions as an TLC block, with data storage capacity tailored to store only three bits per memory cell.

In one embodiment, the memory controller 110 is configured to perform a cell level reconfiguration with respect to a target block of the NV memory 120 if the target block is fully programmed with data (e.g., programmed with host data associated with host write command(s)). In one embodiment, the target block could be a TLC block of a TLC region in the QLC flash memory 120, wherein data is written into the TLC block with one-shot programming during one program cycle. Before the cell level reconfiguration is performed with respect to the target block, a block reliability examination needs to be performed to determine how to perform the cell level reconfiguration.

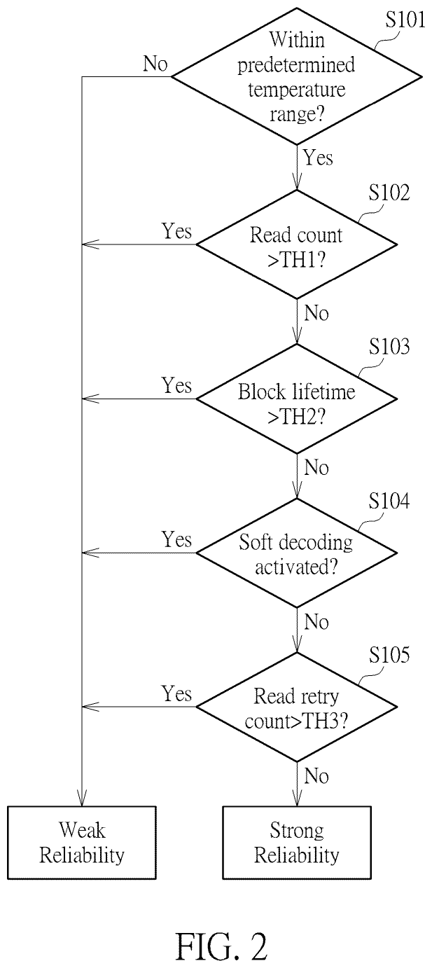

Please refer to FIG. 2, which illustrates a flow chart of performing a block reliability examination on a target block according to one embodiment of the present invention. In step S101, it is determined whether a write temperature regarding data is written to the target block falls within a predetermined temperature range. If yes, the flow proceeds to step S102; otherwise, the flow ends, in which the block reliability indication is generated to indicate that target block exhibits weak reliability. In one embodiment, the predetermined temperature range ranges from about 20° C. to 60° C. That is, if the write temperature regarding the data is written to the target block is lower than 20° C. or higher than 60° C., the target block is considered as having weak reliability.

In step S102, it is determined whether a read count regarding a number of times data in the target block has been read exceeds a predetermined read count threshold TH1. If no, the flow proceeds to step S103. If yes, the flow ends, in which the block reliability indication is generated to indicate that the target block exhibits weak reliability. In one embodiment, the predetermined read count threshold TH1 could be lower than a general read count threshold accepted by blocks of the NV memory 120. Typically, when a read count of a certain block of the NV memory 120 exceeds the general read count threshold, the memory controller 110 would perform a refresh operation on the certain block by moving data thereof to a new/blank block (which is achievable by a GC operation), thereby avoiding potential read disturbance issue of the data in the certain block. However, the predetermined read count threshold TH1 used in the block reliability examination would be lower than the general read count threshold for achieving high reliability requirement. For example, the predetermined read count threshold TH1 would be half the general read count threshold.

In step S103, it is determined whether a block lifetime regarding an elapsed time since the target block is written with data exceeds a predetermined block lifetime threshold TH2. If no, the flow proceeds to step S104; and if yes, the flow ends, in which the block reliability indication is generated to indicate that target block exhibits weak reliability. In one embodiment, the predetermined block lifetime threshold TH2 could be lower than a general block lifetime threshold accepted by blocks of the NV memory 120. Typically, when a block lifetime of a certain block of the NV memory 120 exceeds the general block lifetime threshold, the memory controller 110 would perform a refresh operation on the certain block by moving data thereof to a new/blank block (which is achievable by a GC operation), thereby improving the data retention of the certain block. However, the predetermined block lifetime threshold TH2 used in the block reliability examination would be lower than the general block lifetime threshold for achieving high reliability requirement. For example, the predetermined block lifetime threshold TH2 would be half the general block lifetime threshold.

In step S104, it is determined whether a soft decoding operation performed by the ECC processing circuit 130 has ever been activated in reading data in the target block. If no, the flow proceeds to step S105; and if yes, the flow ends, in which the block reliability indication is generated to indicate that target block exhibits weak reliability. If the soft decoding operation performed by the ECC processing circuit 130 has ever been activated in reading data in the target block, it means that the target block has potential risk of data corruption.

In step 105, it is determined whether a read retry count regarding a number of times a read retry operation has been performed in reading data in the target block exceeds a predetermined read retry count threshold TH3. If no, the flow proceeds to step S106; otherwise, the flow ends, in which the block reliability indication is generated to indicate that target block exhibits weak reliability. In one embodiment, the predetermined read retry count threshold TH3 could be lower than a general read retry count threshold accepted by blocks of the NV memory 120. Typically, when a read retry count of a certain block of the NV memory 120 exceeds the general read retry count threshold, the memory controller 110 would perform a refresh/movement operation on the certain block by moving data thereof to a new/blank block (which is achievable by a GC operation), thereby guaranteeing the data integrity of the certain block. However, the predetermined read retry count threshold TH3 used in the block reliability examination would be lower than the general read retry count threshold for achieving high reliability requirement. For example, the predetermined read retry count threshold TH3 would be half the general read retry count threshold. In step 106, the block reliability indication indicating that the target block exhibits strong reliability is generated.

Once the block reliability indication is generated according to the flow of FIG. 2, the memory controller 110 would select one of a direct conversion mode and a GC-based conversion mode to perform cell level reconfiguration with respect to the target block. If the block reliability indication indicates that the target block exhibits weak reliability, the memory controller 110 would select the GC-based conversion mode for the cell level reconfiguration on the target block. On the other hand, if the block reliability indication indicates that the target block exhibits strong reliability, the memory controller 110 would select the direct conversion mode for the cell level reconfiguration on the target block.

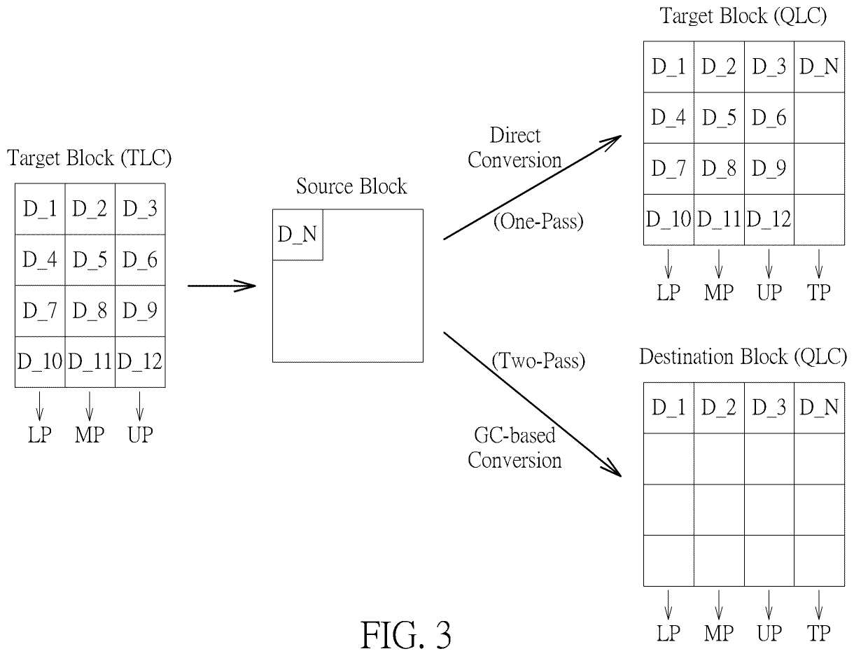

Please refer to FIG. 3 for further understanding. As illustrated FIG. 3, a target block may be a TLC block storing page data D_1-D12, where the page data D_1-D12 could be programmed to the target block through a one-shot programming in a TLC write mode. If the GC-based conversion mode is selected, the memory controller 110 would initiate a GC operation to read the page data D_1, D_2 and D_3 (i.e., the lower page data (LP), the middle page data (MP) and the upper page data (UP) (which may correspond to a same word line)) from the target block as well as read valid one page data D N from a source block in the NV memory 120 that is different from the target block. Accordingly, the memory controller 110 would program the page data D_1, D_2 and D_3 and D N to a (GC) destination block of the NV memory 120 that is different from the target block with two-pass programming. As consequence, the destination block would be configured as a QLC block storing data page data D_1, D_2 and D_3 and D N (i.e., the lower page data (LP), the middle page data (MP), the upper page data (UP) and the top page data (TP)), which is also referred to as a TLC-to-QLC GC-based conversion.

On the other hand, if the direct write conversion mode is selected, the memory controller 110 would read the page data D_1, D_2 and D_3 (i.e., the lower page data (LP), the middle page data (MP) and the upper page data (UP) (which may correspond to a same word line)) from the target block (TLC) as well as read one valid page data D N from a source block in the NV memory 120 that is different from the target block. Accordingly, the memory controller 110 would program the page data D_1, D_2 and D_3 and D N back to the target block with one-pass programming (since a first one-pass programming has been performed on the target block when the target block was configured as the TLC block). As consequence, the target block would be converted from the TLC block to a QLC block storing data page data D_1, D_2 and D_3 and D N (i.e., the lower page data (LP), the middle page data (MP), the upper page data (UP) and the top page data (TP) (which may correspond to a same word line)), which is also referred to as a TLC-to-QLC direct conversion.

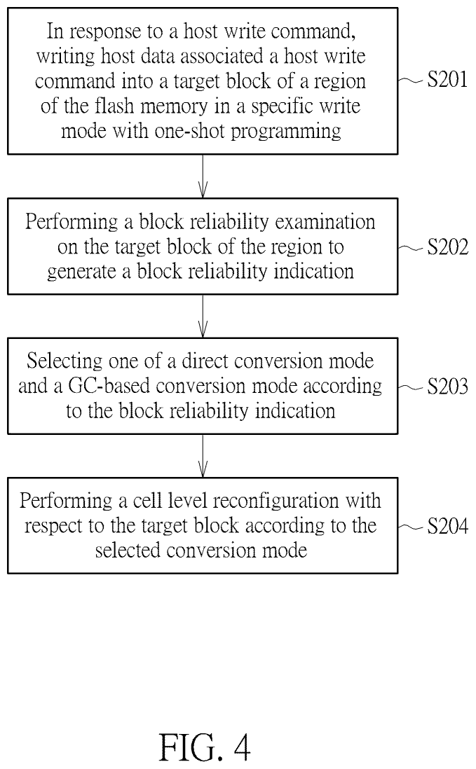

Based on the above embodiments, a method of controlling a flash memory is provided. Please refer to FIG. 4, which illustrates a simplified flow of controlling a flash memory, including the following steps:
S201: in response to a host write command, writing host data associated a host write command into a target block of a region of the flash memory in a specific write mode with one-shot programming;
S202: performing a block reliability examination on the target block of the region to generate a block reliability indication;
S203: selecting one of a direct conversion mode and a GC-based conversion mode according to the block reliability indication; and
S204: performing a cell level reconfiguration with respect to the target block according to the selected conversion mode.

Since principles and specific details of the above steps have been described in detail in previous embodiments, they will not be described again here. It is worth mentioning that the above handling flow can be improved by adding other additional steps or making appropriate modifications and adjustments to improve the performance, endurance and reliability of the QLC flash memory.

In one embodiment, the memory controller 110 may select one of a lifespan-oriented strategy and a performance-oriented strategy. Then, the memory controller 110 configures the NV memory 120 and performs write operations (or other controlling operations) on the NV memory 120 in response to host write commands based on the selected strategy.

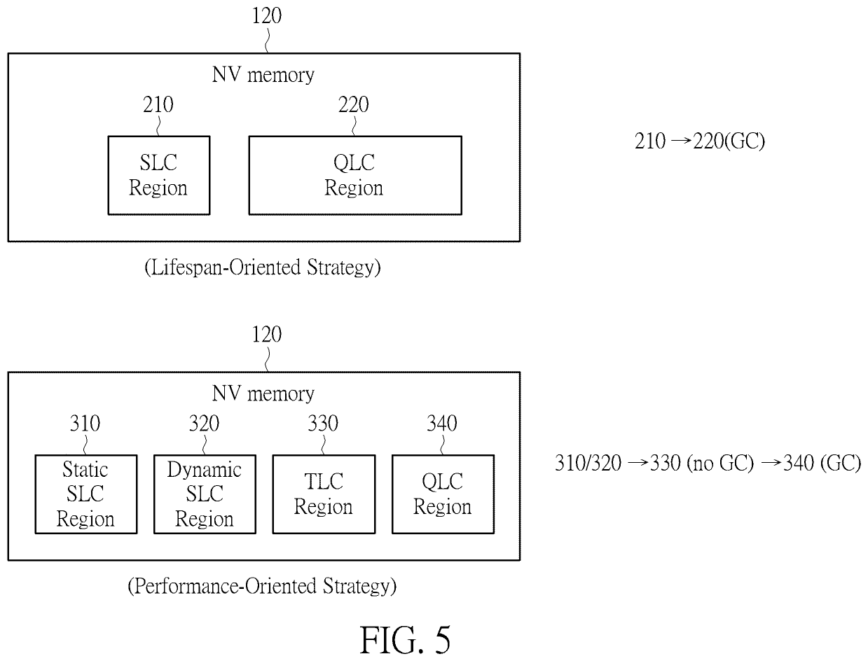

Please refer to FIG. 5 for further understanding. As illustrated by FIG. 5, in the lifespan-oriented strategy, the NV memory 120 will be configured to have a static SLC region 210 containing a plurality of SLC blocks and a QLC region 220 containing a plurality of QLC blocks. In the lifespan-oriented strategy, the memory controller 110 is configured to program host data into SLC blocks of SLC region 210 first. Once an available (remaining) number of SLC blocks of the SLC region 210 goes below a lower bound, the memory controller 110 would perform GC operation to collect valid data from the SLC blocks of the SLC region 210 and accordingly program collected valid data into a QLC block of the QLC region 220 (i.e., SLC-to-QLC GC operation). Moreover, the memory controller 110 would even collect valid data from the QLC blocks of the QLC region 220 and accordingly program collected valid data into a blank QLC block in the QLC region 220. That is, in the lifespan-oriented strategy, the memory controller 110 would perform GC operations as long as the available number of the SLC blocks of the SLC region 210 is not sufficient.

In the performance-oriented strategy, the NV memory 120 will be configured to have a static SLC region 310 and a dynamic SLC region 320 containing a plurality of SLC blocks, a TLC region 330 containing a plurality of TLC blocks and a QLC region 340 containing a plurality of QLC blocks. In the performance-oriented strategy, the memory controller 110 is configured to program host data into SLC blocks of SLC region 310 first. Once an available (remaining) number of the blocks of the static SLC region 310 and/or the dynamic SLC region 320 goes below a lower bound, the memory controller 110 would program host data into TLC blocks of the TLC region 330 with one-shot programming (i.e., TLC direct write). At this moment, an SLC-to-QLC GC operation is not performed. In response to low available number of TLC blocks of the TLC region 330, the memory controller 110 may further perform the above-mentioned cell level reconfiguration (i.e., TLC-to-QLC direct conversion) to reconfigure the TLC blocks as the QLC blocks to store more data. If the available number of TLC blocks of the TLC region 330 and/or the available number of SLC blocks of the SLC regions 310 and 320 is still below the lower bound, the memory controller 110 would perform the GC operation to collect valid data from the SLC blocks of the SLC regions 310 and/or 320 and accordingly program collected valid data into a QLC block of the QLC region 340 (i.e., SLC-to-QLC (S2Q) GC operation), and/or collect valid data from the TLC blocks of the TLC region 330 and accordingly program collected valid data into a QLC block of the QLC region 340 (i.e., TLC-to-QLC (T2Q) GC operation). That is, in the performance-oriented strategy, the memory controller 110 would not perform GC operations immediately after the available number of the SLC region 210 goes below the lower bound since the GC operation are time-consuming. In view of this, the memory controller 110 would perform operations (e.g., TLC direct write or TLC-to-QLC direct conversion) to delay the decrease in write performance before performing the GC operation.

According to one embodiment, the memory controller 110 would select one of the lifespan-oriented strategy and the performance-oriented strategy according to a wearing condition indication value which reflects the wearing status of the NV memory 120. In one embodiment, the memory controller 110 would select the performance-oriented strategy for controlling the NV memory 120 first. If the wearing condition indication value exceeds a predetermined threshold (meaning that the wearing status of the NV memory is significant), the memory controller 110 would select the lifespan-oriented strategy. In the performance-oriented strategy, the memory controller 110 would determine the wearing condition indication value according to a maximum of program/erase (P/E) cycles of the blocks of the dynamic SLC region 320, a maximum of P/E cycles of the blocks of the TLC region 330 and a maximum of P/E cycles of the blocks of the QLC region 340. Specially, one P/E cycle of a particular block includes an erase operation to erase data stored in all memory cells in the block and a write operation (program operation) to write data in each page of the block. Alternatively, the memory controller 110 would determine the wearing condition indication value according to an average of program/erase (P/E) cycles of the blocks of the dynamic SLC region 320, an average of P/E cycles of the blocks of the TLC region 330 and an average of P/E cycles of the blocks of the QLC region 340. In one embodiment, the wearing condition indication value could be determined by: (DSLC P/E)*f1+ (TLC P/E)*f2+ (QLC P/E), where “DSLC P/E” may be a maximum (or an average) of P/E cycles of the blocks of the dynamic SLC region 320, “TLC P/E” may be a maximum (or an average) of P/E cycles of the blocks of the TLC region 330 and “QLC P/E” may be a maximum (or an average) P/E cycles of the blocks of the QLC region 340. In addition, weighting factors f1 and f2 could be any values smaller than “1”. This approach enables the simultaneous assurance of the write performance (for instance, by selecting the performance-oriented strategy) while considering the wearing of the NV flash memory 120 (for instance, by selecting the lifespan-oriented strategy), thus preventing the decline in the lifespan of the NV flash memory 120 due to an excessive focus on performance.

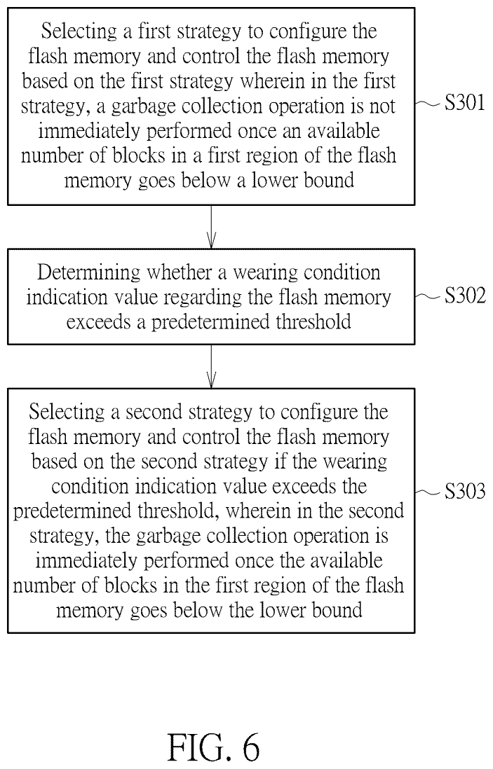

Based on the above embodiments, a method of controller a flash memory is provided. Please refer to FIG. 6, which illustrates a simplified flow of controlling a flash memory, including the following steps:
S301: selecting a first strategy to configure the flash memory and control the flash memory based on the first strategy wherein in the first strategy, a garbage collection operation is not immediately performed once an available number of blocks in a first region of the flash memory goes below a lower bound;
S302: determining whether a wearing condition indication value regarding the flash memory exceeds a predetermined threshold; and
S303: selecting a second strategy to configure the flash memory and control the flash memory based on the second strategy if the wearing condition indication value exceeds the predetermined threshold, wherein in the second strategy, the garbage collection operation is immediately performed once the available number of blocks in the first region of the flash memory goes below the lower bound.

Since principles and specific details of the above steps have been described in detail in previous embodiments, they will not be described again here. It is worth mentioning that the above handling flow can be improved by adding other additional steps or making appropriate modifications and adjustments to improve the performance, endurance and reliability of the QLC flash memory.

Embodiments in accordance with the present embodiments can be implemented as an apparatus, method, or computer program product. Accordingly, the present embodiments may take the form of an entirely hardware embodiment, an entirely software embodiment, or an embodiment combining software and hardware aspects that can all generally be referred to herein as a “module” or “system.” Furthermore, the present embodiments may take the form of a computer program product embodied in any tangible medium of expression having computer-usable program code embodied in the medium. In terms of hardware, the present invention can be accomplished by applying any of the following technologies or related combinations: an individual operation logic with logic gates capable of performing logic functions according to data signals, and an application specific integrated circuit (ASIC), a programmable gate array (PGA) or a field programmable gate array (FPGA) with a suitable combinational logic.

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It is also noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions. These computer program instructions can be stored in a computer-readable medium that directs a computer or other programmable data processing apparatus to function in a particular manner, such that the instructions stored in the computer-readable medium produce an article of manufacture including instruction means which implement the function/act specified in the flowchart and/or block diagram block or blocks.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a flash memory, comprising:
in response to a host write command, writing host data associated a host write command into a target block of a region of the flash memory in a specific write mode with one-shot programming;
performing a block reliability examination on the target block of the region to generate a block reliability indication;
selecting one of a direct conversion mode and a garbage collection-based (GC-based) conversion mode according to the block reliability indication; and
performing a cell level reconfiguration with respect to the target block according to the selected conversion mode.

2. The method of claim 1, wherein the step of performing the cell level reconfiguration with respect to the target block according to the selected conversion mode comprises:
reading a lower page data, a middle page data and an upper page data from the target block;
reading a valid page data from a source block of the flash memory that is different from the target block; and
if the direct conversion mode is selected, programming the lower page data, the middle page data and the upper page data from the target block as wells as the valid page data from the source block into the target block in a QLC write mode with one pass programming.

3. The method of claim 1, wherein the step of performing a cell level reconfiguration with respect to the target block according to the selected conversion mode comprises:
reading a lower page data, a middle page data and an upper page data from the target block;
reading a valid page data from a source block of the flash memory that is different from the target block; and
if the GC-based conversion mode is selected, programming the lower page data, the middle page data and the upper page data from the target block as well as the valid page data from the source block into a GC destination block that is different from the target block in a QLC write mode with two pass programming.

4. The method of claim 1, wherein the step of performing the block reliability examination on the target block comprises:
generating the block reliability indication according to whether a write temperature regarding data is written to the target block falls within a predetermined temperature range;
generating the block reliability indication according to whether a read count regarding a number of times data in the target block has been read exceeds a predetermined read count threshold;
generating the block reliability indication according to whether a block lifetime regarding an elapsed time since the target block is written with data has been read exceeds a predetermined block lifetime threshold;
generating the block reliability indication according to whether a soft decoding operation has ever been activated in reading data in the target block; and/or
generating the block reliability indication according to whether a read retry count regarding a number of times a read retry operation has been performed in reading data in the target block exceeds a predetermined read retry count threshold.

5. The method of claim 1, wherein the step of selecting one of the direct conversion mode and the GC-based conversion mode according to the block reliability indication comprises:
selecting the direct conversion mode if the block reliability indication indicates that the target block exhibits strong reliability; and
selecting GC-based conversion mode if the block reliability indication indicates the target block exhibits weak reliability.

6. The method of claim 1, wherein the flash memory is a quad-level cell (QLC) flash memory, and the target block is a triple-level cell (TLC) block of a TLC region of the QLC flash memory, in which 3-bit data is written per memory cell in the TLC region.

7. A memory controller for use in a flash memory, comprising:
a storage unit configured to store program codes;
a processing unit configured to execute the program code to perform operations on the flash memory, comprising:
in response to a host write command, writing host data associated with the host write command into a target block of a region of the flash memory in a specific write mode with one-shot programming;
performing a block reliability examination on the target block of the region to generate a block reliability indication;
selecting one of a direct conversion mode and a garbage collection-based conversion mode according to the block reliability indication; and
performing a cell level reconfiguration with respect to the target block according to the selected conversion mode.

8. A data storage device comprising a memory controller of claim 7 and a flash memory.

9. A method of controlling a flash memory, comprising:
selecting a first strategy to configure the flash memory and control the flash memory based on the first strategy;
determining whether a wearing condition indication value regarding the flash memory exceeds a predetermined threshold; and
selecting a second strategy to configure the flash memory and control the flash memory based on the second strategy if the wearing condition indication value exceeds the predetermined threshold;
wherein in the first strategy, a garbage collection operation is not immediately performed once an available number of blocks in a first region of the flash memory goes below a lower bound; and in the second strategy, the garbage collection operation is immediately performed once the available number of blocks in the first region of the flash memory goes below the lower bound.

10. The method of claim 9, wherein the first strategy is performance-oriented strategy and the second strategy is a lifespan-oriented strategy.

11. The method of claim 10, wherein the step of selecting the first strategy to configure the flash memory comprising:
configuring the flash memory to have at least the first region having a plurality of blocks of a first type, a second region having a plurality of blocks of the first type, a third region having a plurality of blocks of a second type a forth region having a plurality of blocks of a third type; and
if the available number of the blocks of the first type goes below a lower bound, programming data to the blocks of the second type in the third region with one-shot programming without performing the GC operation.

12. The method of claim 11, wherein the wearing condition indication value is determined according to a weight sum of a maximum of program/erase (P/E) cycles of the blocks of the first type in the second region, a maximum of P/E cycles of the blocks of the second type in the third region and a maximum of P/E cycles of the blocks of the third type in the fourth region.

13. The method of claim 12, wherein the blocks of the first type in the second region are single-level cell (SLC) blocks in a dynamic SLC region, the blocks of the second type in the third region are triple-level cell (TLC) blocks in a TLC region and the blocks of the third type in the fourth region are quad-level cell (QLC) blocks in a QLC region.

14. The method of claim 10, wherein the step of selecting the second strategy to configure the flash memory comprising:
configuring the flash memory to have at least the first region having a plurality of blocks of a first type and a second region having a plurality of blocks of a second type; and
if the available number of the blocks of a first type goes below a lower bound, programming the GC operation to move valid data from the blocks of the first type in the first region to a block of the second type in the second region before programming data into the blocks of the first type in the first region.

15. The method of claim 14, wherein the blocks of the first type in the first region are SLC blocks in a SLC region and blocks of the second type in the second region are QLC blocks in a QLC region.

16. A memory controller for use in a flash memory, comprising:
a storage unit configured to store program codes;
a processing unit configured to execute the program code to perform operations on the flash memory, comprising:
selecting a first strategy to configure the flash memory and control the flash memory based on the first strategy;
determining whether a wearing condition indication value regarding the flash memory exceeds a predetermined threshold; and
selecting a second strategy to configure the flash memory and control the flash memory based on the second strategy if the wearing condition indication value exceeds the predetermined threshold;
wherein in the first strategy, a garbage collection operation is not immediately performed once an available number of blocks in a first region of the flash memory goes below a lower bound; and in the second strategy, the garbage collection operation is immediately performed once the available number of blocks in the first region of the flash memory goes below the lower bound.

17. A data storage device comprising a memory controller of claim 16 and a flash memory.
